(19) United States
(12) Patent Application Publication
(10) Pub. No.: US 2006/0024129 A1
(43) Pub. Date: Feb. 2, 2006

(54) Flat connecting hook

(76) Inventors: Melanie John, Freiburg (DE); Uwe Nutto, Freiburg (DE)

Correspondence Address: GUDRUN E. HUCKETT DRAUDT, LONSSTR. 53, WUPPERTAL, 42289, DE

(21) Appl. No.: 10/527,104

(22) PCT Filed: Sep. 11, 2003
(86) PCT No.: PCT/DE03/03025

§ 371 Date: Mar. 10, 2005

(30) Foreign Application Priority Data
Sep. 15, 2002 (DE) 202 14 286.8

(51) Int. Cl. F16B 21/00

(52) U.S. Cl. 403/329

(57) ABSTRACT

A connecting element for suspending an article from a structural element and for detachably connecting several articles with one another has a center part, a first lateral end area and a second lateral end area, wherein a first bent area connects the first lateral end area to the center part and a second bent area connects the second lateral end area to the center part. The first and second end areas are positioned within a common first plane and the center part is positioned in a second plane. The first plane and the second plane are parallel to one another and spaced at a spacing from one another. The spacing between the first and second planes is defined by a height of the first and second bent areas, respectively. The connecting element has two lateral openings; or a central cutout; or two lateral openings and a central cutout.

The invention relates to a connecting element having the features of the preamble of claim 1.

Such a connecting element is disclosed in DE 19640621 C1. This connecting element is a hook element and can be suspended from a rod or the like or can be connected to a second hook element. The hook element has in the area of its center part a lateral opening. It is disadvantageous that the known L-shaped hook element can be produced only by pressure diecasting or injection molding processes. When connecting two hook elements, one hook element with a right lateral opening and another hook element with a left lateral opening are required. Accordingly, the industrial manufacture of such known hook elements requires at least two different pressure diecasting or injection molding tools, a first one which provides the hook with a right lateral opening and a second one which provides the hook with a left lateral opening.

The object of the invention is thus seen in that the known connecting element is to be further developed in that it can be produced simply and inexpensively and is still dimensionally stable and load-resistant.

As a solution to this object it is proposed according to the invention that the connecting element according to the preamble of claim 1 is configured in accordance with the characterizing portion of said claim.

The connecting element according to the invention is no longer L-shaped but instead of a mirrored double L-shape, i.e., approximately E-shaped. By means of this E-shape the connecting element is made more dimensionally stable than the L-shaped hook. In industrial manufacture, pressure diecasting tools or injection molding tools are no longer needed. The connecting element according to the invention can be cut or even stamped, for example, from sheet steel. In order to connect two articles with one another by means of the connecting element, on both articles at least one identical connecting element is attached. When the articles are now placed opposite one another with their back, respectively, the first connecting element with its two lateral openings can be slid into the two lateral openings of the oppositely positioned second connecting element. Since two articles are now connectable with identically configured connecting elements, the necessity for producing two different pressure diecasting tools or injection molding tools, as required in the case of the known hook element, is eliminated. In comparison to the known hook element, the connecting element according to the invention is of a flat configuration wherein the first lateral end area and the second lateral end area are positioned approximately within the same plane and wherein the center part because of the bent area is displaced either above or below this plane.

The lateral openings are arranged advantageously in the bent areas wherein one lateral opening is provided within one bent area, respectively. The bent areas can be angled at angles of different size. Expediently, the two bent areas however are of identical configuration so that the center part has the same vertical spacing relative to the first lateral end area and also relative to the second lateral end area. In other words, the plane in which the center part is positioned and the plane in which the two lateral end areas are positioned are parallel to one another and have a spacing that results from the height of the bend. Relative to a center plane that extends transversely to the connecting element, a mirror-symmetrical configuration of the connecting element is advantageously provided.

In comparison to the known hook element, the connecting element according to the invention has the additional advantage that because of the entire flat configuration of the connecting element two articles can be connected to one another at a minimal spacing. The known hook element was of a rather thick-walled configuration so that, when connecting two articles by means of these hook elements, a relatively large spacing between the articles would result, and this is very disadvantageous depending on the application.

The connecting element moreover can have a central tapering cutout so that it can not only be suspended from a rod but also from a mushroom-shaped pin. In this way, it is achieved that an attachment on a mushroom-shaped pin also provides a very tight connection.

Depending on the application, the central cutout can be arranged differently. One embodiment of the invention therefore provides that the central cutout is formed so as to open in an opening direction that is opposite to the opening direction in which the two lateral openings open. A further configuration of the invention provides that the central cutout opens in the same opening direction as the opening direction of the two lateral openings.

Joining of two connecting elements is facilitated when the lateral openings advantageously have slanted contact surfaces. Also, the central tapering cutouts can advantageously be provided with slanted contact surfaces.

When employing several E-shaped connecting elements, two articles can be combined along a circular movement path in that the connecting elements have slanted contact surfaces in the area of their lateral openings and are attached to the articles in a position rotated by 90°.

The invention will be explained in the following in more detail with the aid of the drawing. The drawing shows embodiments of the invention. It is shown in:

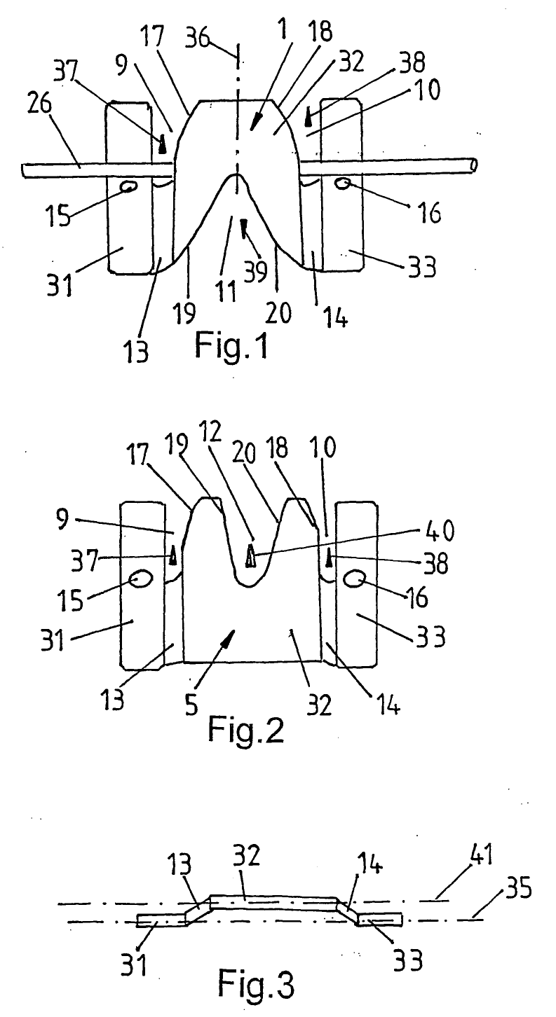

FIG. 1 a schematic plan view of a first embodiment of the connecting element according to the invention;

FIG. 2 a schematic plan view onto another embodiment of the connecting element;

FIG. 3 a front view according to FIG. 2;

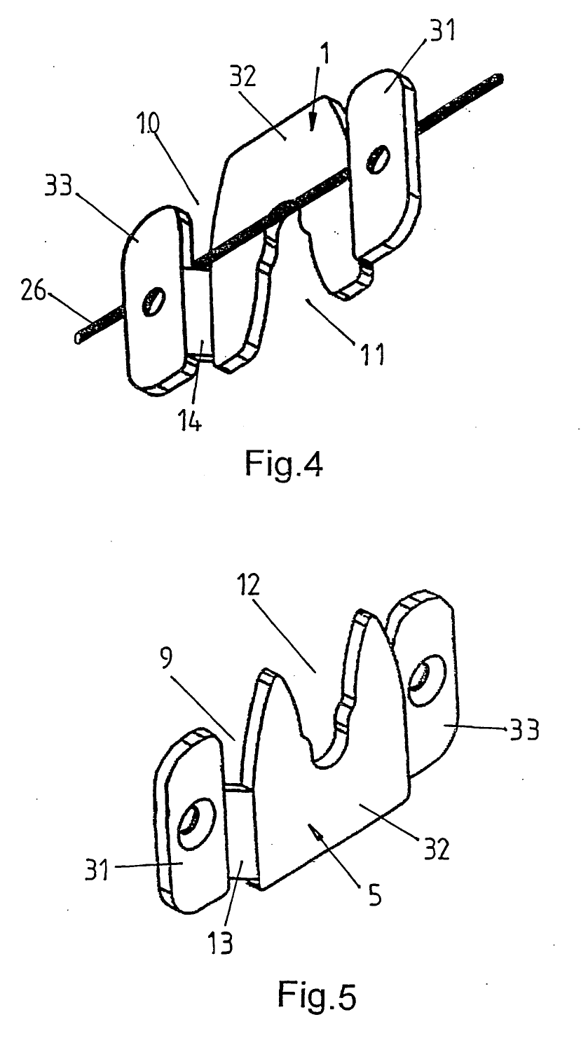

FIG. 4 a perspective view of the connecting element according to FIG. 1 from the rear;

FIG. 5 a perspective view of the connecting elements according to FIG. 2;

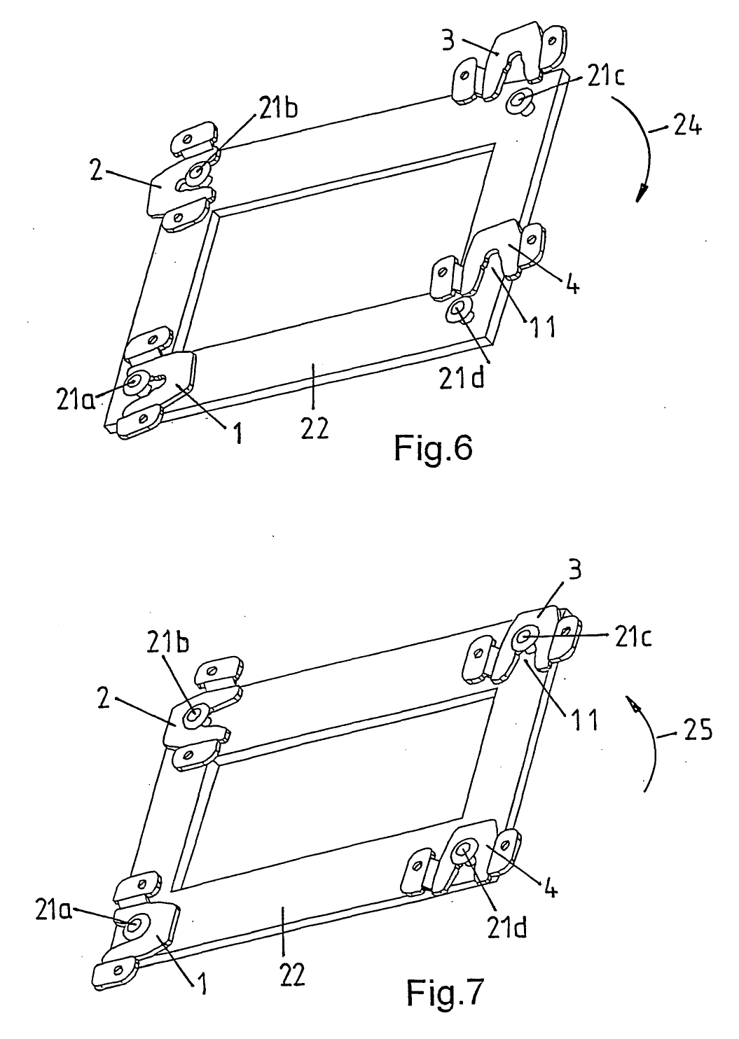

FIG. 6 the process of connecting by means of a rotational movement four connecting elements according to FIG. 1 to four pins that are mounted on a frame;

FIG. 7 the connection of four connecting elements according to FIG. 1 with four pins mounted on a frame;

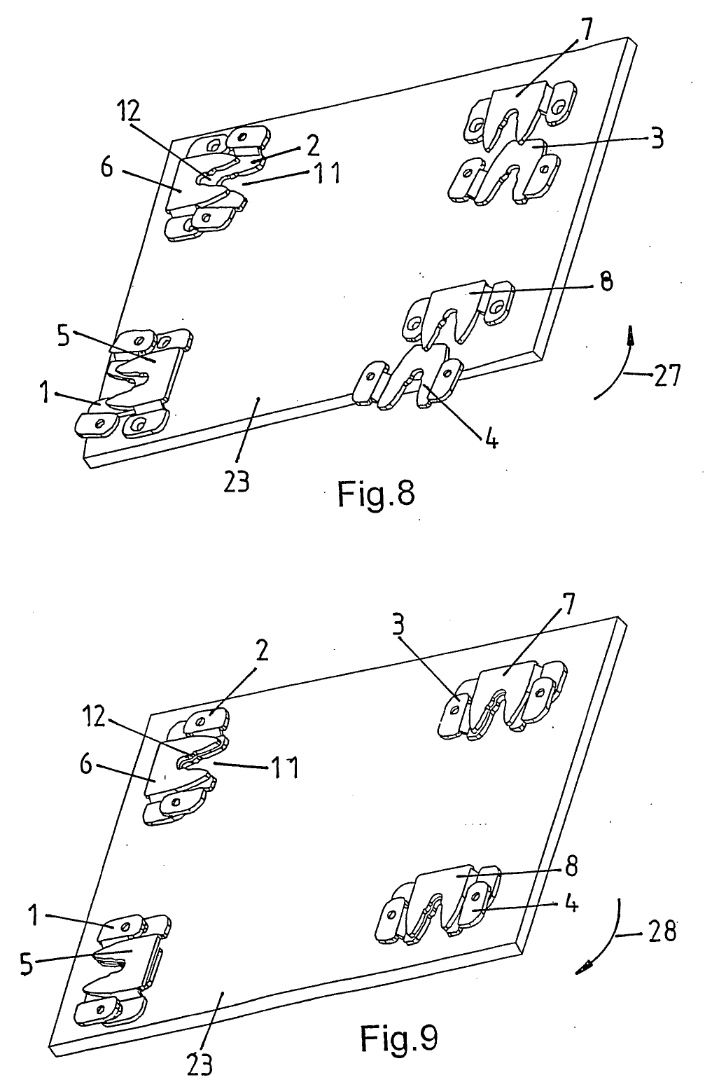

FIG. 8 the process of connecting by means of a rotational movement four connecting elements according to FIG. 1 to four connecting elements according to FIG. 2 that are mounted on a plate; and

FIG. 9 the connection of four connecting elements according to FIG. 1 with four connecting elements according to FIG. 2 that are mounted on a plate.

The connecting element 1 illustrated in FIG. 1 has a first lateral area 31, a center part 32, and a second lateral end area 33; all are flat and are arranged sequentially when viewed from the left to the right. The first end area 31 is connected to the center part 32 by a bent area or angled area 13. Also, the center part 32 is connected to the end area 33 by a bent area or angled area 14. As shown in FIG. 3, the two bent areas 13, 14 are angled such that the center part 32 relative to a plane 35 that extends through the two end areas 31 and 33 is positioned above said plane 35 within a plane 41. The bent area 13 has a lateral opening 9 and the bent area 14 has a lateral opening 10. The center part 32 has a central cutout 11 that is symmetrical to a center axis 36. In the connecting element according to FIG. 1, the lateral openings 9, 10 are aligned such that an opening direction 37 of the lateral opening 9 and an opening direction 38 of the lateral opening 10 are oriented opposite to an opening direction 39 of the cutout 11. For attachment of the connecting element to a backpack or a bag, on the lateral end areas 31, 33, an attachment point or fastening point 15, 16 is provided approximately centrally, respectively.

In the connecting element 5 according to FIG. 2, there is also a central cutout 12 provided on the center part 32. The opening direction 40 of this central cutout 12 extends however in the same direction as the opening directions 37 and 38 of the lateral openings 9, 10. In other respects, this connecting element 5 according to FIG. 2 is identical to the connecting element 1 according to FIG. 1.

The connecting elements 1 and 5 can be suspended with their lateral openings 9, 10 from a rod 26. Moreover, the central cutouts 11, 12 ensure connection of the connecting elements 1, 5 with a pin 21 as illustrated in FIGS. 6 and 7.

The connecting element 1 and 5 are connected to one another in that the connecting element 1 with its two lateral openings 9 and 10 that are located within the end areas 13 and 14 is pushed into the two lateral openings 9, 10 of the connecting element 5. It is also possible to connect two connecting elements 1 with one another wherein the lateral opening 9 of the first connecting element 1 is pushed into the lateral opening 9 of the second connecting element 1 and the lateral opening 10 of the first connecting element 1 is pushed into the lateral opening 10 of the second connecting element 1. The connection of two connecting elements 5 is realized in the same way.

By means of the fastening points or attachment points 15 and 16, a flush fixation on an article by means of rivets, screws or the like can be realized.

On the center part 32 in the area of the lateral opening 9 a slanted contact surface or rounded portion 17 and in the area of the opening 10 a slanted contact surface or rounded portion 18 are provided. These slanted contact surfaces 17 or 18 are required in order to connect two connecting elements by means of a rotational movement with one another. Moreover, the cutout 11 is provided in its outer areas with slanted contact surfaces 19 and 20 and the cutout 12 is also provided at its outer areas with slanted contact surfaces 19, 20. These slanted contact surfaces 19, 20 are required in order to connect the connecting element 1 and 5 in a rotational movement to a pin.

In FIG. 6, the process of connecting four connecting elements 1 according to FIG. 1 to four pins 21 mounted on a frame 22 by means of a rotational movement is illustrated. In order to connect an article 23 that has four identical connecting elements 1 to 4 mounted in a flush arrangement on its back to four pins 21 by a rotational movement, it is required that the connecting elements 1 to 4 are positioned at 90° or 180° angles to one another. The connection is realized in that first the connecting element 1 is pushed onto the pin 21a. By means of the rotational movement 24 to be carried out subsequently, the connecting element 2 that is rotated relative to the connecting element 1 by 180° is connected to the pin 21b; the connecting element 3 that is rotated relative to the connecting element 1 by 90° is connected to the pin 21c; and the connecting element 4 that is also rotated by 90° relative to the connecting element 1 is connected to the pin 21d. In the embodiment illustrated in FIG. 6, the pin 21a provides the center of rotation for the rotational movement 24.

When employing four connecting elements 5, the connecting process is carried out in the same way, provided the respective central cutouts 12 face in the same direction as the central cutouts 11 illustrated in FIG. 6.

FIG. 7 shows the completed connection of the connecting elements 1 to 4 with the pins 21a to 21d; this connection is secured in three directions by the described arrangement of the connecting elements rotated by 90° or 180°. For releasing the connection, the afore described rotary movement 24 must be carried out in the opposite direction 25 wherein the pin 21a provides the center o rotation, as indicated above. When using four connecting elements 5 (not illustrated), the release process is carried out in the same way, provided the central cutouts 12 face in the same direction, respectively, as the central cutouts 11 illustrated in FIG. 6.

In FIG. 8, the process of connecting by means of a rotary movement four connecting elements according to FIG. 2 to four connecting elements according to FIG. 1 that are mounted on an article 23 is illustrated. In order to connect the article 23 with its connecting elements 5 to 8 arranged flush thereat by means of a rotation movement with a second article to which the connecting elements 1 to 4 are attached so as to be flush therewith, it is required that the connecting elements 1 to 4 are positioned to one another as illustrated in FIGS. 6 and 7 and the connecting elements 5 to 8 are positioned relative to one another as illustrated in FIG. 8. The connection is realized in that first the connecting element 2 with its lateral openings 9 and 10 is pushed into the connecting element 6 with its lateral openings 9 and 10 wherein first the opening 10 engages the opening 10 and then the opening 9 engages the opening 9. By means of the rotational movement 27 to be carried out subsequently, the connecting elements are connected with one another, i.e., 1 with 5, 3 with 7, and 4 with 8.

FIG. 9 shows the completed connection of the four connecting elements according to FIG. 2 with four connecting elements according to FIG. 1 wherein in this situation the connection is also secured in three directions. As can be seen, the central cutouts 11 and 12 of the connecting elements 1 and 5 that are connected to one another in pairs face in the same direction, respectively. For release of the connection, the afore described rotational movement 27 must be carried out in the opposite direction 28. In practice, for example, when connecting two motorcycle bags to a bag carrier, by means of the same orientation of the central cutouts the following advantage results: Both bags can be suspended as desired from the left or right of the bag carrier wherein (viewed in the travel direction) the same movement courses are performed which makes handling very simply. The centers of rotation (left side of the carrier and right side of the carrier) where the rotational movements originate are positioned mirror-symmetrical to one another, wherein the motorcycle represents essentially the mirror axis.

What is claimed is:

1-12. (canceled)

13. A connecting element for suspending an article from a structural element and for detachably connecting several articles with one another, the connecting element comprising:
a center part;
a first lateral end area and a second lateral end area;
a first bent area connecting the first lateral end area to the center part and a second bent area connecting the second lateral end area to the center part;
wherein the first and second end areas are positioned within a common first plane and wherein the center part is positioned in a second plane;
wherein the first plane and the second plane are parallel to one another and are spaced at a spacing from one another;
wherein the spacing between the first and second planes is defined by a height of the first and second bent areas, respectively; and
wherein the connecting element has two lateral openings; or a central cutout; or two lateral openings and a central cutout.

14. The connecting element according to claim 13, wherein the first and second bent areas each have one of the two lateral openings.

15. The connecting element according to claim 13, wherein the first and second bent areas are identical.

16. The connecting element according to claim 15 having a mirror-symmetrical configuration relative to a central plane extending through the center part.

17. The connecting element according to claim 13, wherein the central cutout opens in an opening direction that is oriented opposite to opening directions of the two lateral openings.

18. The connecting element according to claim 13, wherein the central cutout and the two lateral openings open in a same opening direction.

19. The connecting element according to claim 13, wherein the central part has slanted contact surfaces in the area of the two lateral openings.

20. The connecting element according to claim 13, wherein the central cutout has slanted contact surfaces.

21. The connecting element according to claim 13, wherein several of said connecting elements are mounted on an article in positions rotated by 90° or 180° relative to one another and are adapted to be connected by a rotational movement to several pins.

22. The connecting element according to claim 13, wherein several of said connecting elements are mounted on a first article in positions rotated by 90° or 180° relative to one another and are adapted to be connected by a rotational movement to several identical ones of said connecting elements mounted on a second article in positions rotated by 90° or 180° relative to one another.

23. The connecting element according to claim 13, wherein the connecting element is comprised of angled sheet metal.

24. The connecting element according to claim 13, wherein the first and second lateral end areas have attachment points.
